(19) United States
(12) Patent Application Publication
(10) Pub. No.: US 2007/0030454 A1
(43) Pub. Date: Feb. 8, 2007

(54) Digital cinema projector module and retrofit therefor

(76) Inventor: David S. Richards, Costa Mesa, CA (US)

Correspondence Address: NATH & ASSOCIATES, PLLC, 112 South West Street, Alexandria, VA, 22314, US

(21) Appl. No.: 11/500,484

(22) Filed: Aug. 8, 2006

Related U.S. Application Data
(60) Provisional application No. 60/705,815, filed on Aug. 8, 2005.
(60) Provisional application No. 60/780,931, filed on Mar. 9, 2006.
(60) Provisional application No. 60/785,495, filed on Mar. 24, 2006.

(51) Int. Cl. G03B 17/02

(52) U.S. Cl. 352/242; 353/119

(57) ABSTRACT

A digital cinema projector set has a digital cinema projector module including a digital light engine and a lamp assembly having a light source and a light path dimensionally configured for the module to substantially occupy space intended for a lamphouse within a console for film projection. The module may include projector guide rails which allow the module to be installed in a console having corresponding console guide rails. The module or just its lamp assembly may be sufficient for use as a light source during projection of traditional film. The light path may include a folded light path using a prism with various coatings. The set may include an electrical filter circuit which maintains current ripple at or below a level sufficient for digital projection. The module may be removed and the original light equipment returned. A method of retrofitting all film projection consoles and a system therefor are provided.

This application claims the benefit of U.S. Provisional Application No. 60/705,815 filed Aug. 8, 2005; U.S. Provisional Application No. 60/780,931 filed Mar. 9, 2006; and, U.S. Provisional Application No. 60/785,495 filed Mar. 24, 2006. The aforementioned provisional applications' disclosures are all incorporated herein by reference in their entirety.

### BACKGROUND OF THE INVENTION

Motion pictures have been exhibited in cinema theatres for entertainment purposes for over 100 years, using photographic film and a projector device. Early systems consisted of three separate components: a carbon arc lamphouse mounted on a pedestal; a film projector mounted on the front of the lamphouse; and the ballast or power supply for the lamp, located externally, connected to the lamphouse through an umbilical cable.

Carbon arc lamps required constant supervision and adjustment, and were therefore very labor intensive to operate in this application. Various means of automating the running of these systems evolved over the following decades, with the most important development being the replacement of the carbon arc with high-pressure xenon lamps, deployed in theatres in large numbers beginning in the 1970s. This eliminated the need for a full-time projectionist for each screen, and spawned the birth of the multiplex cinema complex. Soon thereafter, the common method of packaging these systems evolved from three separate components to two components: the lamp power supply or ballast was moved into the base of an enclosure which also housed the lamp and other optical components, along with the new automatic control system. The control system senses optical or magnetic materials attached to the film at various points in the program, which automatically trigger functions such as starting the xenon lamp, dimming the lights, opening and closing curtains, and so forth. This new enclosure was termed a film “console”. The console also became the support frame for mounting the projector component on its front side.

Digital video projection technology is a more modern technology that will eventually replace film projection systems in cinema theatres. It was introduced in theatres experimentally in the late 1990s, and production models became available around 2002. This new digital technology is now becoming mature, yet has been slow to be adopted in theatres for a variety of reasons, including cost of the equipment and logistical issues. The following major issues are believed to be holding up the rollout of the new digital units for this application:

1. Cost. The digital systems are very expensive, currently about 3-4 times that of an equivalent mechanical film system. Ways to reduce the purchase price must be found before this digital cinema revolution will gain any momentum.

2. Access to the Projection Booth for installation. The digital systems currently being offered for this application are similar in size and shape to their film system predecessors: approximately four feet long, three feet wide, and five feet high (−60 cu ft), and 400 lbs or more in weight. In other words they are bulky and heavy. Very few theatre sites provide an elevator for moving equipment into and out of projection rooms. Most new theatres have the film equipment lifted up to the mezzanine level by forklift or crane before the walls are in place during initial construction. It will be fairly difficult and expensive to move new equipment into these existing venues. A large digital unit simply can not be installed in many of these sites without cutting holes in their walls or roofs, because of the difficulty of moving the systems through narrow stairwells and doorways.

3. Access to the Projection Booth for removal. The existing film consoles weigh hundreds of pounds and are bulky. Just as the digital systems are difficult to move in, the existing film equipment will be difficult and expensive to remove. The market for surplus film equipment of this type is fairly limited already, and this market will dwindle even further once the D-cinema rollout is in full swing and surplus film equipment becomes even more commonplace. These film systems will essentially become junk, and the theatre owner will have to pay money to someone to remove and haul them away. In some cases the systems may have to be disassembled or even cut into pieces to get out of the projection rooms. The used film system will have little or no residual value, the majority of them most likely ending up in metal scrap yards or landfills.

4. Alignment. A substantial amount of labor is involved in installing a new projection system. For example, the console/projector must be accurately located to be aimed at the center of the projection screen, in 4 axes of positioning: lateral or left-right physical movement to align with the projection port; azimuth, or “aiming” of the projector left-right to align with the screen center; leveling left-to right tilt for a level horizon; and elevation, or tilt up and down to align the image to the screen center. It can take hours to properly align a new projection system to the screen.

5. Power and cooling. As part of a new equipment installation, local codes may require a certified electrician to be present when connecting any new equipment into the 3-phase power. This will involve additional expense. In addition, the hot exhaust air must be ducted outside the projection room. The current digital systems are somewhat shorter, and thus existing exhaust hoses may need to be replaced with longer ones.

6. Auxiliary devices and wiring. Most existing film systems include much of the wiring for the ancillary equipment for the entire auditorium in the base of the film projection console. This may include the automation control system, life/safety equipment, often dimmers for the auditorium lighting, and sometimes even the audio processors and amplifiers. Wiring may also be present for components not located within the cinema console, but still getting their power via circuit breakers located in the console. This may include items such as the film platter system, the screen curtains, screen masking motors, aisle lighting, decorative lighting on the walls of the auditorium, and various other accessories. With all this equipment and accessories connected inside the base of the console, it wouldn't be uncommon to have close to 100 individual wire terminations present. Multiply that by the number of screens in the multiplex, and it becomes clear there will be a tremendous amount of labor associated with transferring all these components and the associated wiring from the existing film console to a new digital system.

### SUMMARY OF THE INVENTION

The present inventive subject matter relates to a novel digital projection system module that can be easily installed into existing film consoles. This lowers the cost substantially, makes the digital system smaller and easier to retrofit into existing sites, and avoids removing and scrapping existing equipment and wiring that is still functional. Only the film projector itself and a few optical components become surplus, while nearly everything else is reused.

In some embodiments, the present inventive subject matter relates to a digital cinema projector set having a digital cinema projector module. In some embodiments, the digital cinema projector module includes a digital light engine and a lamp assembly having a light source and a light path. The path of travel of light is in-line (meaning in substantially one direction). Alternatively, the light path can include various bends. The light source and light path may be dimensionally configured for the digital cinema projector module to substantially occupy space intended for the lamphouse within a console for film projection. The set may include a lamp power supply, or the existing lamp power supply may be reused. The set may also include an adjustable power control device, whereby the digital cinema projector system determines and controls power level delivered by the lamp power supply, and which allows automated or remote adjustment of the power supply output, and also permits remote monitoring of current status.

In some further embodiments, the module includes projector guide rails which allow the module to be installed in a console having console guide rails. The projector guide rails and console guide rails may be partially or entirely made of a material with a low coefficient of friction. The console guide rails may form a track on which the projector guide rails may glide. The console guide rails may be aligned so that an output beam of the module, when installed in the console, projects an image aligned to a screen.

In some further embodiments, the digital cinema projector module is sufficient for use as a light source during projection of traditional film. The set may include a relay optical system able to focus the module output into about an F/2.0 light cone for use as a light source for projection of traditional film. In some further embodiments, the lamp assembly alone is sufficient for use as a light source during projection of traditional film.

In some further embodiments, the light path includes: an approximate 90-degree prism which uses total internal reflection at a hypotenuse glass-air interface; a prism with an angle substantially less than 90 degrees, such as 70-80 degrees, which uses total internal reflection at a hypotenuse glass-air interface; a prism which uses a dielectric coating on a hypotenuse surface, the coating allowing unwanted radiation to pass through while reflecting visible light in a range between approximately 400 nm and approximately 700 nm in wavelength at approximately a right angle; a prism with an input face, an output face, and bandpass anti-reflection coating disposed at the input face and at the output face, the coating passing visible light in a range between approximately 400 nm and approximately 700 nm in wavelength, and reflecting light outside of that range; a prism which uses a concave input face and a convex output face; and/or, a prism which reduces the angles of the light cone within the prism so as to enhance Total Internal Reflection at a hypotenuse glass-air interface.

In some further embodiments, the set includes an electrical filter circuit capable of maintaining current ripple at or below a level sufficient for digital projection, such filter providing an instant current rate-of-rise sufficient to ignite a xenon lamp, and steady-state current sufficient to maintain the ignition. The electrical filter circuit limits current ripple to approximately 2% or less at all times, except when starting the lamp, at which time it allows the current to rise over approximately one millisecond thereby minimizing stress to lamp electrodes.

In some further embodiments, the digital cinema projector module has a width no greater than approximately 18″, a height no greater than approximately 16″, a length no greater than approximately 28″, and a weight no greater than approximately 150 lbs. In some further embodiments, the module is dimensionally configured to substantially replace one or more existing sets of lamphouse components in consoles such as Strong International: X90, Highlight II, Super Highlight II models; Christie Digital Systems: SLC models; Big Sky: C2000 through C7000, Deluxe models; Xetron (Division of Neumade): XCN, XCND, XH, XHN models; and Moving Image Technologies: XLC models. The module can also be dimensionally configured for removal of the digital cinema projector module and return of the original lamphouse components to the film projection console.

The present inventive subject matter also relates to a method of retrofitting a film projection console with a digital cinema projector module. The method includes: disconnecting wiring which connects a lamp to the console; removing lamphouse components from within the console; removing a film projector from the front side of the console; and placing a digital cinema projection module inside the console. The method may also include opening or removing at least one door from the console; and/or replacing a door with at least one new door configured to accommodate and enclose protrusions from the digital cinema projection module.

In some embodiments, placing a digital cinema projection module into the console may include mounting guide rails at the console and gliding the digital cinema projection module into the console along the guide rails.

The method may also include wiring a power filter inline between the digital cinema projection module and a new or existing lamp power supply, where the power filter is capable of providing an instant current rate-of-rise sufficient to ignite a xenon lamp, and steady-state current sufficient to maintain the ignition. The power filter is capable of reducing current ripple at or below a level sufficient for digital projection, of approximately 2% or less at all times, except when starting said lamp, when it provides an extended current rise time of approximately one millisecond to minimize stress to lamp electrodes.

The method may also include installing a control module that allows automated or remote adjustment of the power supply output, and thereby lamp brightness, and also permits remote monitoring of status, including operational parameters such as current, voltage, and temperature.

The method may also include installing a lamp module into the digital cinema projection module having a folded light-path configuration from its side, and optionally projecting light within the folded light-path configuration against a prism, thereby causing total internal reflection at a glass-air hypotenuse interface of said prism, or projecting light within the folded light-path configuration against a mirror. In some further embodiments, the method includes replacing at least one door with at least one new door configured to accommodate and enclose protrusions from the light-path configuration.

In some further embodiments, the method includes returning a film projector to the console and projecting light from the digital projection module through film in the film projector. In some further embodiments, the method also includes removing the digital projection module from the console, and returning original lamphouse components to the console. The method may include removing a snood from the console, wiring the digital projection module to the console, and/or aligning the light output of the digital projection module to project with maximum intensity onto a screen.

In some further embodiments, the method also includes: cutting off a top of said console, with a reciprocating or rotary saw, plasma cutter, torch, or laser, adding a platform to the top of a remaining portion of the console, and mounting the digital projection module onto the platform. In some further embodiments, the method also includes removing the digital projection module from the console, reattaching the top of the console using welding or brackets, and returning the original lamphouse components to the console.

The present inventive subject matter also relates to a system for retrofitting a film projection console. The system includes means for disconnecting wiring which connects a lamp to the console, means for removing optical components including the lamp and a reflector from the console, means for removing an optical bench from the console, means for removing a film projector from the console, and means for placing a digital cinema projection module inside the console. The system can also include: means for removing and returning the door or doors to the console, and means for enclosing protrusions of the said digital cinema projection module.

The system may also include means for gliding the digital cinema projection module into the console along the guide rails. In some further embodiments, the system may include means for wiring a power filter inline between the digital cinema projection module lamp and a new or existing lamp power supply, where the power filter is capable of reducing current ripple to approximately 2% or less at all times, thereby maintaining current ripple at or below a level sufficient for digital projection, except when starting a xenon lamp when it provides an instant current rate-of-rise sufficient to ignite said lamp, and steady-state current sufficient to maintain the ignition. The power filter is capable of slowing the current rise time to approximately one millisecond to minimize stress to lamp electrodes.

The system may also include means for installing a control module that allows automated or remote adjustment of the power supply output, and also permits remote monitoring of status.

In some further embodiments, the system includes means for installing a lamp module into the digital projection module having a folded light-path configuration from its side; and means for enclosing protrusions from the folded light-path configuration.

The system may also include means for returning a film projector to the console, and means for projecting light from the digital projection module through film in the film projector.

In some further embodiments, the system includes means for removing the lamphouse components from the console, means for removing a snood from the console, means for wiring the digital cinema projection module to the console, and/or means for aligning the light output of the digital cinema projection module to project with maximum intensity onto a screen. The system may also include means for cutting off a top of the console, means for adding a platform to the top of a remaining portion of the console; and means for mounting the digital cinema projection module onto the platform.

The system may also include means for removing the digital cinema projection module from the console, means for reattaching the top of the console; and means for returning said lamphouse components to said console.

### BRIEF DESCRIPTION OF THE FIGURES

In the detailed description of the invention presented below, reference is made to the accompanying drawings in which:

FIG. 1 shows a top view of an embodiment of a digital cinema projector set according to the present inventive subject matter;

FIG. 2 shows a top view of an alternate embodiment a digital cinema projector set according to the present inventive subject matter.

FIG. 3 shows a top view of a light source and light path according to an alternate embodiment of the present inventive subject matter.

FIG. 4 shows a top view of a light source and light path according to an alternate embodiment of the present inventive subject matter.

FIG. 5 shows a rear view of an alternate embodiment of a digital cinema projector set according to the present inventive subject matter.

FIG. 6 shows a filter circuit for use according to the present inventive subject matter.

FIG. 7 shows a power and light path according to the present inventive subject matter.

FIG. 8 shows a perspective view of an alternate embodiment of the present inventive subject matter.

FIGS. 9A, 9B, and 9C show flowcharts for a method according to the present inventive subject matter.

FIGS. 10A, 10B, and 10C show a side view of an alternate embodiment of the present inventive subject matter.

### DETAILED DESCRIPTION OF THE INVENTION

In the following detailed description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and logical changes may be made without departing from the scope of the present invention. The following detailed description, therefore, is not to be taken in a limiting sense, and the scope of the present invention is defined by the appended claims.

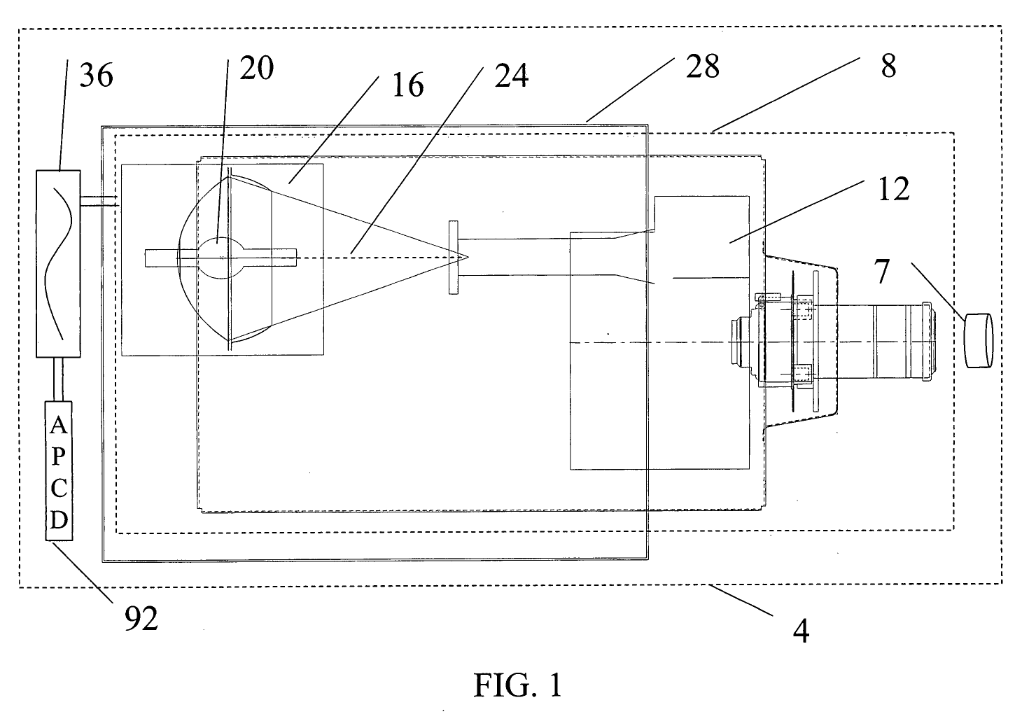

As shown in FIG. 1, a first embodiment of the present inventive subject matter relates to a digital cinema projector set 4 having a digital cinema projector module 8. The module 8 as described here may be a self-contained unit for projecting digital images, dimensionally configured to substantially occupy the space 28 intended for a lamphouse within a console for film projection. (The term lamphouse may refer to some or all of the light source and optical and mechanical components used during conventional film projection to illuminate the film passing through the mechanical projector). The module may, alternatively, comprise one or more separate subunits which together fit in space 28. Once installed in space 28, the projection lens of the module 8 may protrude through the snood where the xenon light previously emerged from the lamphouse on the front side of the console, and portions of module 8 may extend outside of space 28. At its light engine core, the module may incorporate image display technology such as Texas Instruments Digital Light Processing (DLP®), DLP-Cinema®; Sony SXRD™; Liquid Crystal Display (LCD); or other image display technologies.

Many different digital light engines are known and could be used in this application, including those manufactured by Barco, Christie, NEC, Sony, Texas Instruments, Toshiba, Mitsubishi, and others. In some embodiments, the module 8 is dimensionally configured to substantially replace one or more existing sets of lamphouse components in consoles such as Strong International: X90, Highlight II, Super Highlight II models; Christie Digital Systems: SLC models; Big Sky: C2000 through C7000, Deluxe models; Xetron (Division of Neumade): XCN, XCND, XH, XHN models; and Moving Image Technologies: XLC models.

In the present embodiment, the digital cinema projector module 8 includes a digital light engine 12 and a lamp assembly 16 having a light source 20 and a light path 24. The digital light engine 12 receives illumination on the light path 24 and modulates it to present the cinema image.

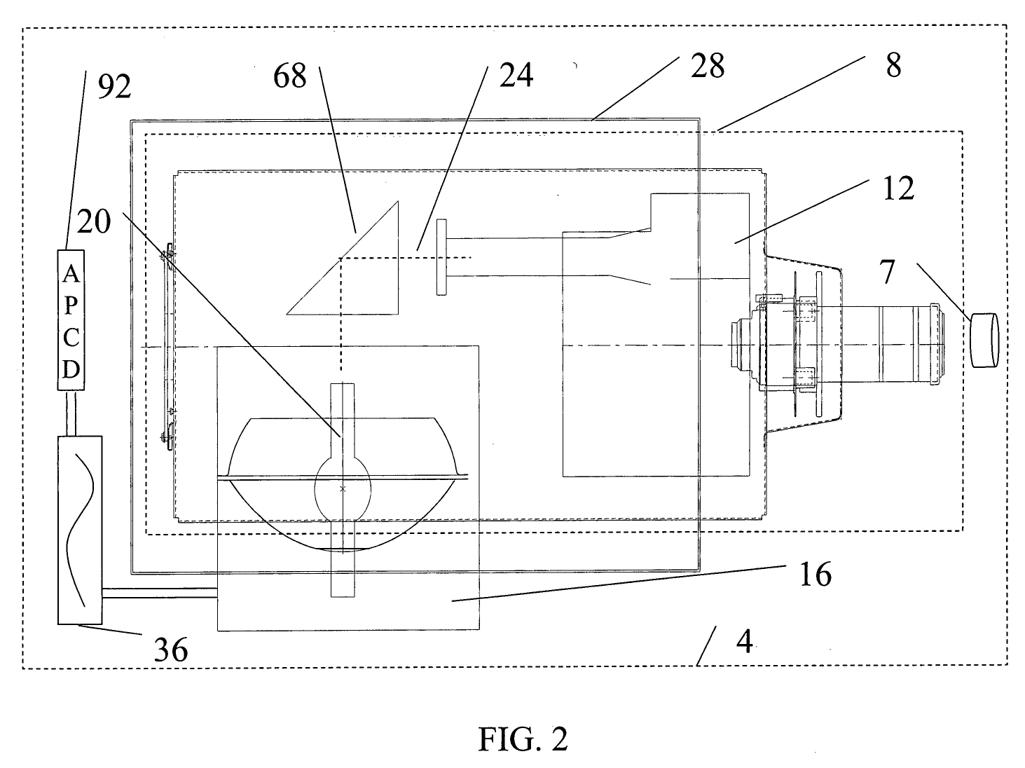

The light source 20 and light path 24, as part of the module 8, may be dimensionally configured for the digital cinema projector module 8 to substantially occupy space 28. Different techniques can be used, individually or in combination, to produce a module 8 which can substantially occupy space 28. As nonlimiting examples, the module 8 may have light projected from the light source 20 directly into the digital light engine 12, or may have the light source 20 placed at the side of the module 8 and reflect the light path 24 off of a mirror or prism, as will be described below with FIG. 2. As further nonlimiting examples, components such as the digital light engine 12 can be produced at a smaller scale, and the light source 20 and light path 24 can be chosen to reduce cost, power usage, and minimize heat production. In all of these examples, the goal is the same: a digital cinema projection module 8 which can substantially occupy the space 28 intended for a lamphouse in a console designed to supply illumination for a film projector. It should be noted that the lamp assembly 16 need not be permanently installed with the module 8, but may be installed in the module 8 after the module 8 has been installed in the console 32.

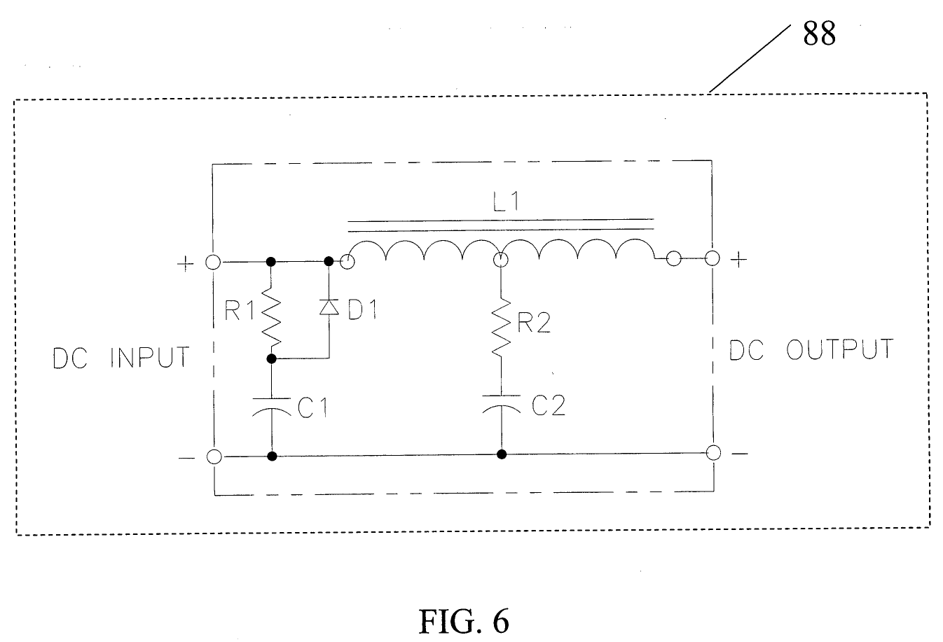

The set 4 may include a lamp power supply 36. The lamp power supply may be a part of the module 8, or may be separate from the module 8 and kept outside of space 28, connected to the module 8 by wires. When a lamp power supply 36 is not provided with the set 4, the module 8 may be designed to utilize an existing lamp power supply present at the console. As digital cinema projection has different electrical demands than traditional film projection, in the quality of electricity, a filter may be required, as will be described below with reference to FIG. 6.

Although the power supply 36 may be separate from the module 8, the set 4 may also include an adjustable power control device 92, whereby the digital cinema projector module 8 determines and controls the power level delivered by the lamp power supply 36. In contrast, many of the existing power supplies utilized for motion picture projection have their power output controlled with a manually operated switch, adjusted periodically by an operator. This mode of operation would prevent the new digital projector module from adjusting lamp output automatically. The adjustable power control device 92 allows the digital projector module 8 to adjust lamp output. The adjustable power control device 92 may consist of resistive load banks, switched in and out of the circuit by contactors, relays, or other electromechanical means. The adjustable power control device 92 may alternately include active devices (transistors and other solid-state devices) utilized in a linear current regulating fashion. Other embodiments may include similar solid-state devices, but used in a switching regulator configuration. In either case suitable heat sinks are provided to cool the active devices. This power control module includes an analog or digital input to control the power level delivered. It may also include sensor devices to output telemetry information to the external control system, such information consisting of: the current being delivered; voltage being delivered; cooling fan status, temperature, or other system health status information.

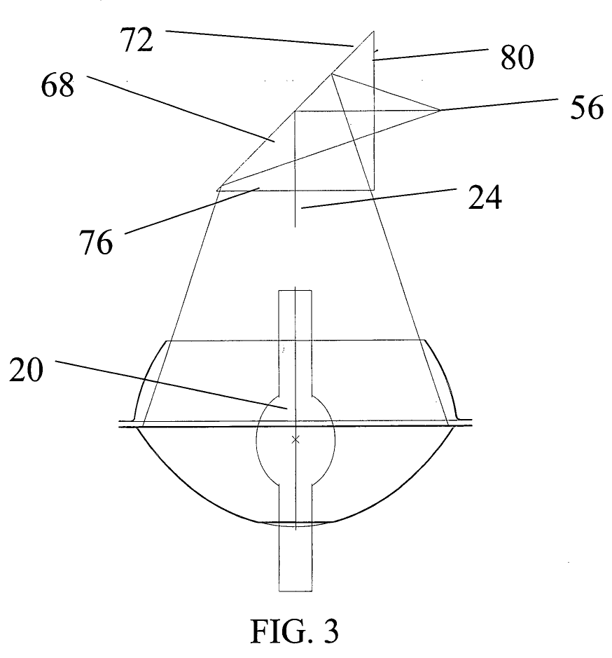

Making reference now to FIGS. 2 and 3, in some further embodiments, the light path 24 includes a prism 68. By using prism 68, the present inventive subject matter allows the beam path 24 to take up less space, which better allows module 8 to fit in space 28. This bend in the light path may be approximately 90 degrees, and can be accomplished with a dichroic-coated “cold” mirror positioned at an angle, whereby the mirror reflects visible light but allows some of the heat from the lamp to pass straight through, However, it is difficult to produce dichroic-coated cold mirrors with a sharp band cutoff, so visible light is often lost along with the heat. For improved efficiency and other advantages, the throughput light efficiency of the system is improved in one embodiment of this invention by using a prism 68 in the light path instead of a mirror, or in the previous embodiment of FIG. 1 by eliminating the angled mirror or prism altogether.

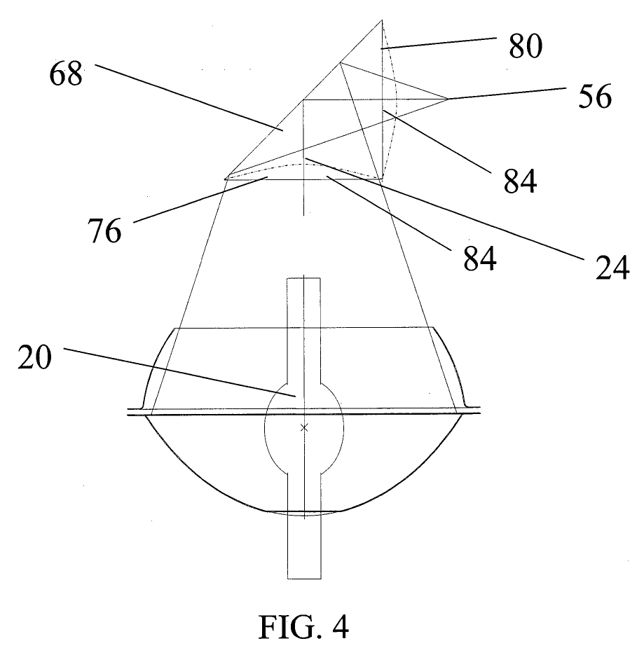

Prism 68 may be made out of glass for smaller systems, but as the xenon lamp produces a significant amount of heat, in larger systems (and even in smaller systems) the prism 68 may be made of a material that can withstand higher temperatures. Non-limiting examples of such materials include fused silica, or a zero-expansion glass ceramic such as “Zerodur” manufactured by the Schott company. Such a prism can be designed to utilize the principle of Total Internal Reflection (TIR) at the hypotenuse glass-to-air interface 72. For TIR to occur, all light rays reaching the prism hypotenuse 72 must be at a greater angle than the critical angle (as a non-limiting example, approximately 42 degrees for glass with a refractive index of 1.5). If the angular spread of the light is such that some of the rays strike the hypotenuse 72 at angles of incidence less than the critical angle for TIR to occur, additional methods (not shown) may be used to reduce the angular spread of the beam, such as reducing the light path bend angle to less than 90 degrees (as a non-limiting example, 70-80 degrees, although angles as low as 45 degrees are possible), placing a negative lens between the light source and the prism, or implementing a spherical or cylindrical concave surface on the prism input face 76, as shown in FIG. 4. If a negative lens or concave surface is utilized on the input face 76, a positive lens may then be inserted in the beam after the prism 68, or a spherical or cylindrical convex surface may be applied to its output face 80, to restore the appropriate optical speed, or F number.

As a further way to control unwanted heat within the light beam while minimizing space occupied by the beam length, prism 68 may use a dielectric coating on the hypotenuse glass-air interface 72, the coating allowing unwanted radiation to pass through, while reflecting visible light in a range between approximately 400 nm and approximately 700 nm in wavelength at about a 90-degree angle.

Prism 68 may incorporate a bandpass anti-reflection coating 84 on its input face 76 or on both input 76 and output 80 faces, to enhance the passage of visible light while rejecting wavelengths shorter than 400 nm or greater than 700 nm. The bandpass behavior accomplishes a similar operation as the angled mirror, but with greater efficiency, in part because the beam path 24 is nearly normal with faces 76 and 80, and because the coating operates in a transmissive mode rather than a reflective mode. The input face 76 of the prism may be tilted at a small angle so that out-of-bandpass reflected radiation can be collected in a beam dump. In other embodiments additional dichroic coatings may be applied to the hypotenuse 72 of the prism in addition to, or instead of the input 76 and output 80 faces. In other embodiments, a separate bandpass filter may be placed either before or after the prism 68, at a convenient small angle so that out-of-bandpass radiation can be collected in a beam dump. All of these techniques may be used individually or in combination with each other.

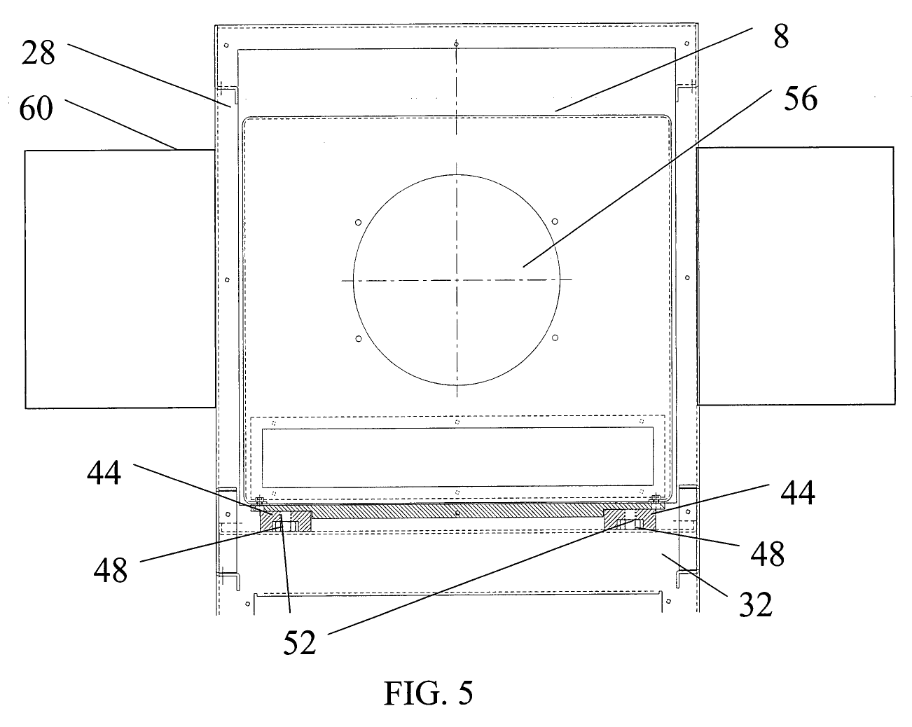

Making reference now to FIG. 5, an aspect of the present inventive subject matter involves improving ease of installation, increasing speed and accuracy of alignment, and simplifying changing back and forth between digital presentations and 35 mm film presentations in a theatre, depending on the requirements in the field at the time. To this end, module 8 can include projector guide rails 44 which allow the module 8 to be installed in a console having console guide rails 48. These projector guide rails 44 can be a set of machined surfaces incorporated into the baseplate of the module, and can be accompanied by a set of two console guide rails 48 which are permanently installed into the existing console. These console guide rails 48 can correspond to the projector guide rails 44. The projector guide rails 44 and console guide rails 48 may be partially or entirely made of a material with a low coefficient of friction, such as Teflon, nylon, delrin, or UHMW polyethylene. Although these guide rails are not required for the present inventive subject matter, they facilitate both the installation of module 8, and the replacement of module 8 with traditional illumination equipment. In addition, the rails 44, 48 form a “standardized” system for installation, facilitating extremely easy upgrades as digital projector technology improves.

For use, the projector guide rails 44 are slideably engaged with the corresponding console guide rails 48, and the module 8 glides into the console 32. In this manner, the console guide rails serve as a track 52 on which the module 8 may glide, although guide rails could also be placed on other sides of space 28 for alignment aid. To facilitate switching between digital projection and traditional projection, the standard illumination system for 35 mm film (which was removed from the console 32 when it was modified to accommodate module 8) may be mounted to a baseplate with its own projector guide rails 44. In this way, one can easily glide out digital module 8 and return the standard illumination system to the console.

The console guide rails 48 can be aligned at installation so that when the module 8 is finally engaged in console 32, it is aligned so that its output beam 56 projects an image aligned to a screen 60, as shown in FIG. 5. Accordingly, if a standard illumination system is reengaged in console 32 by way of the console guide rails 48, it too is aligned so that its output beam 56 projects normal to the film surface and directly toward the screen 60.

To this end, it should be noted that in some further embodiments, the module 8 is sufficient for use as an illumination source during projection of traditional film. If so, the module 8 need not be replaced by a standard illumination system for the projection of traditional film. Rather, a film projector and projection lens may be replaced in front of the light output of the module 8. The module 8 then projects even, high-quality full-spectrum light (that is, unmodulated by the digital light engine 12) normal to the film surface and toward a screen. Alternately, intentional modulation of the light engine 12 may be employed to alter the color or pattern of light produced on the screen, either to correct defects or inconsistencies in the light produced, or for creative effect. When used in this mode, the set 4 may include a relay optical system 7 able to focus the output of module 8 into about an F/2.0 light cone for use as a light source for projection of traditional film. However, other optical solutions are known in the art and are available for modifying the output of the module 8 to make it suitable for film projection, and may involve chromatic adjustment or filtering, beam shaping, or intensity modulation. Alternately, just the projector module lamp assembly 16 may be sufficient for use as an illumination source for projection of traditional film, thereby avoiding the need for relay optics.

In any case, the module 8 can also be dimensionally configured for removal of the digital cinema projector module 8 and return of the original lamphouse components to the film projection console when needed.

In providing a module 8 which can fit into space 28, it was previously stated that providing an external power supply 36 can advantageously reduce the size and weight of the module 8. To this end, it may be advantageous to utilize the power supply previously provided for the traditional illumination system. However, sensitivities of the advanced digital light engine electronics, along with the nature of modern illumination systems, requires that the quality of the DC current obtained with typical power supplies used in the industry, such as high-reactance (magnetic, otherwise known as reactive-type), or certain types of solid-state or switching power supplies such as those used with the traditional illumination system, be improved. Specifically, the AC ripple component must be lowered, often to less than about 2% current ripple at the DC output. Without proper reduction of the ripple at the DC output, the light output pulsates as a result of the AC ripple riding on the supplied DC current. This pulsation, which is normally undetectable with traditional film projection, causes a beating effect with the digital light engine modulation, making it more objectionable. A large majority of the power supplies existing in the field are reactive-type, and most reactive-type supplies used in the art typically have 4-5% current ripple. To provide a satisfactory stable light level for a digital projection system, these power supplies must have additional filtering applied. There are also solid-state switching-type supplies in common use. While their ripple level may be very good with regard to ripple at AC power line frequencies, they often have excessive ripple at frequencies in the kilohertz range, that result in long-term degradation of lamp electrodes, and therefore also benefit from filtering in order to offer improved life and performance of the lamp.

A problem with standard DC filter circuits known in the art is a specific conflicting requirement: although the circuit must smooth out fluctuations occurring over several milliseconds, it also must allow the instantaneous current to rise very rapidly at the moment the xenon lamp is started, within about one millisecond. These opposing requirements can be met by using an electromechanical relay which shorts out some portion of the filter circuit until after heavy current flow begins. However, an alternate solid-state method for controlling ripple while allowing for a sufficient current rise is disclosed as part of the present inventive subject matter.

Making reference to FIG. 6, the set 4 may include an electrical filter circuit 88 capable of providing an instant current rate-of-rise sufficient to ignite a xenon lamp, but still capable of providing an extended current rise time of approximately one millisecond to minimize stress to lamp electrodes, and allowing a current ripple of approximately 2% or less at all times, except when starting the lamp, thereby maintaining current ripple at or below a level sufficient for digital projection. The present inventive subject matter utilizes a capacitor C1 which helps provide current to the lamp during the moments after ignition, as the current flow through inductive choke L1 builds up. In operation, 100-150 VDC is present at the input of the circuit prior to the lamp starting. Capacitor C1 charges up through resistor R1 within approximately 1 second after voltage is initially applied. Capacitor C2 also charges during this time, through resistor R2 and one half of inductor L1. R2 has a low value which has little effect during the charging period but has another important function. Within a second or two of voltage being applied, the voltage at the output of the circuit rises to about the same value as at the input. The igniter device in the console lamphouse senses this voltage level and applies an ignition pulse to the lamp. At the instant an arc is established across the lamp, current immediately begins flowing out of C2. During this period, R2 limits the current flow to a low enough value to prevent damage to the lamp electrodes, (usually 3-4 times the maximum continuous current rating of the lamp) and at the same time R2 extends the time that charge from C2 is available to the lamp, to several milliseconds. Inductor L1 inhibits the current from rising rapidly, so capacitor C1 provides additional current and assists the current ramp-up in L1, the C1 current being connected through diode D1. Diode D1 is a type that can handle at least several hundred amperes for a brief period. Once the lamp is operating normally, the ripple filtering is primarily accomplished by the two-pole filter created by L1 and C2, with a small amount of added filtering from C 1. Depending on the current rating of the power supply and the lamp, capacitor C1 and C2 usually have a value of 5,000 to 20,000 microfarads, resistor R1 is 10 to 50 ohms, R2 is a fraction of an ohm, and inductor L1 has an inductance between 200 and 1000 microhenries. L1 must also be constructed using a wire gage sufficient to withstand the maximum continuous current flow of these systems, up to about 180 amperes on the larger systems. It is to be understood that this is merely one fairly simple embodiment of one potential filtering circuit that has been shown to be useful and reliable in this application, there are a variety of other filter circuits that may be used which will be obvious to those skilled in the art. As a non-limiting example, the circuit of FIG. 6 can simply be “inverted”, with the choke being applied on the negative side of the supply. As another non-limiting example, the filter circuits may include active circuits having transistors or other semiconductors.

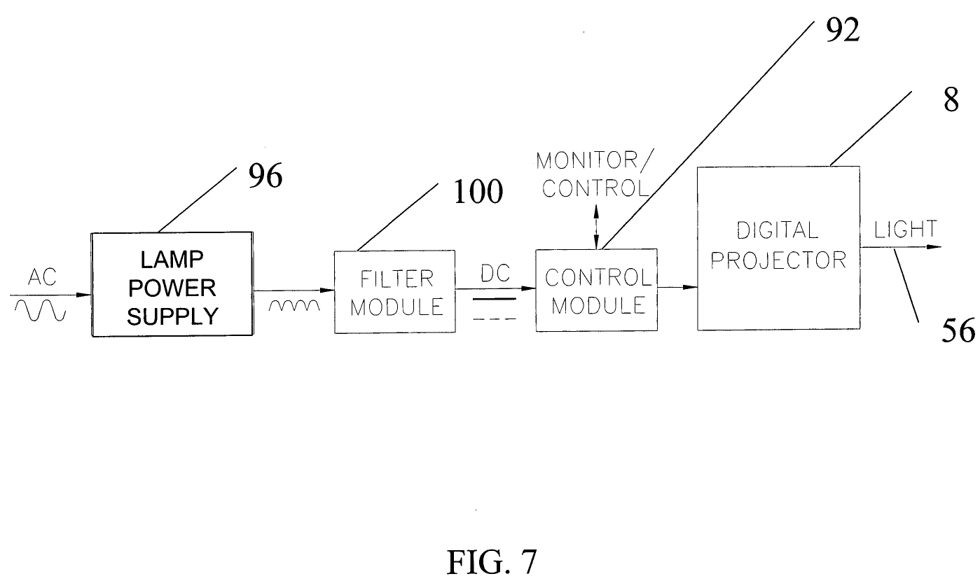

Making reference to FIG. 7, it can be seen that the flow of power proceeds from an AC input through a DC lamp power supply 96, and then optionally into a filter module 100 comprising filter circuit 88 according to the present inventive subject matter. The filtered DC output of filter module 100 is then optionally passed through the advanced power control device 92 described above (which may itself draw power from this input, or from an external source). Alternatively, the filter module 100 and the control device 92 can be reversed such that the flow of power proceeds first to the control device. There, an operator or a processor (or other control means) disposed in the module may control the power output. This DC voltage proceeds to module 8, where it powers the light source 20. Ultimately, the module 8 produces output beam 56 which is projected toward the screen. It is understood that although the filter device described above is required for certain power supplies to be used with digital projection, the power control module described herein constitutes an optional convenience, and may or may not be implemented in some or all installations. In some embodiments of this invention one or more of the filtering devices described above may be combined with the power control device module, into a common enclosure and utilizing some of the same devices or circuitry.

Generally, the dimensional requirements of the module 8 are dictated by the standard sizes of lamphouse components, and of console spaces therefor 28. Generally, a digital cinema projector module 8 having a width no greater than approximately 18″, a height no greater than approximately 16″, a length no greater than approximately 28″, and a weight no greater than approximately 150 lbs is sufficient to substantially fit within the console. However, these are just non-limiting suggestions, and it is to be understood that the present inventive subject matter relates to a module 8 which substantially fits inside a console space 28 generally, and accommodates console spaces of many different dimensions than these.

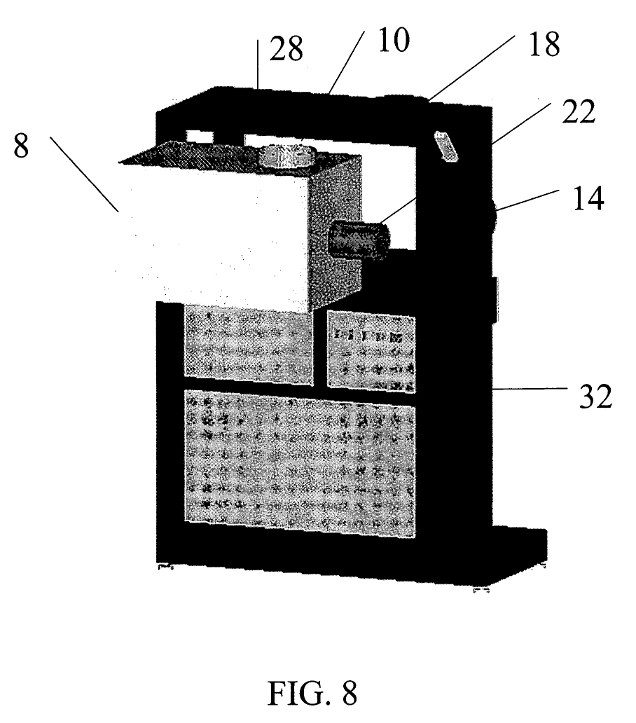

Moreover, making reference to FIG. 8, one can see by way of a non-limiting example an existing film console 32. The lamphouse and doors have been removed, leaving space 28 which is ready for the insertion of module 8. It should be noted that module 8 has an exhaust opening 10 which is aligned, either by original design or through the use of tubing, piping, or other means, to carry heat exhaust out of the module 8 and through the original exhaust opening 18 of the console. It should also be noted that snood 14 has been left on the front of the console 32, and that the module projection lens 22 will extend into and through the snood 14. Finally, it should be noted that the traditional film projector has been removed, but could conveniently be returned to the front of the console 32 should one wish to use module 8 as a light source for the projection of traditional film.

In some further embodiments, the set 4 includes a control module that allows automated or remote adjustment of the power supply output, and thereby lamp brightness, and also permits remote monitoring of current status, including operational parameters such as current, voltage, and operating temperature.

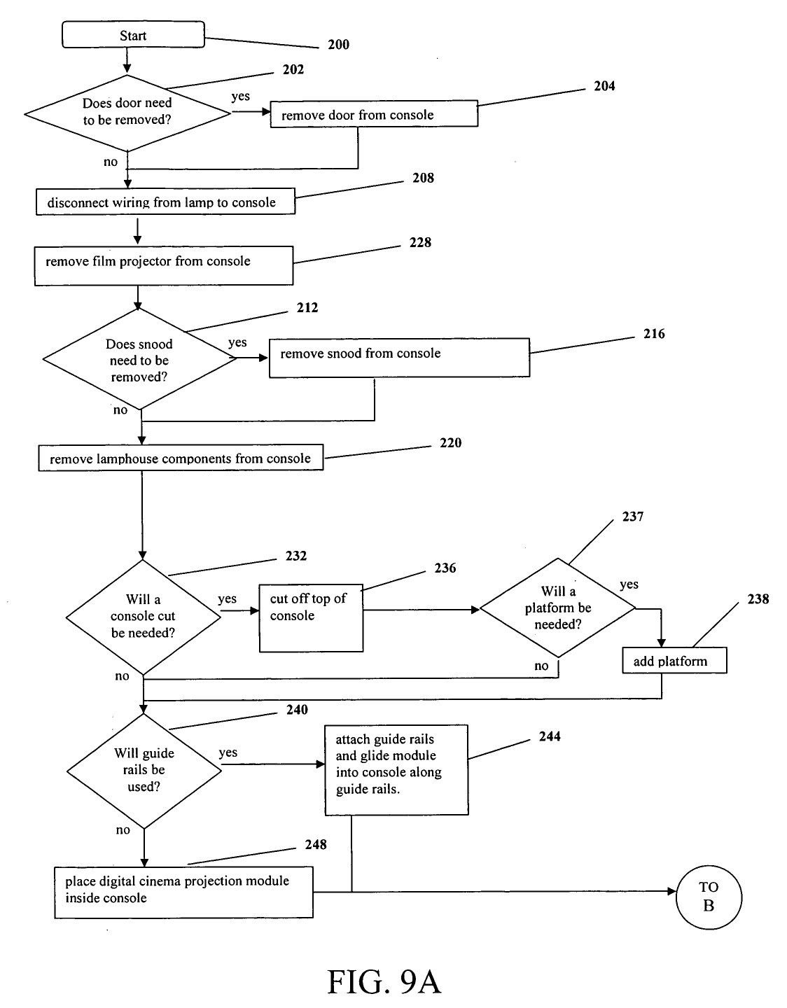

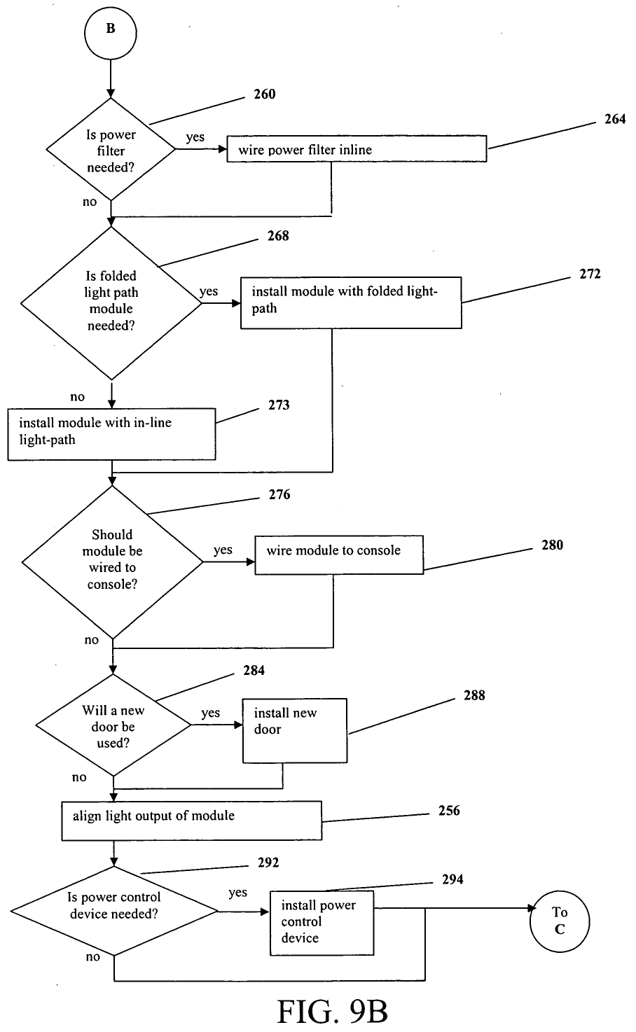

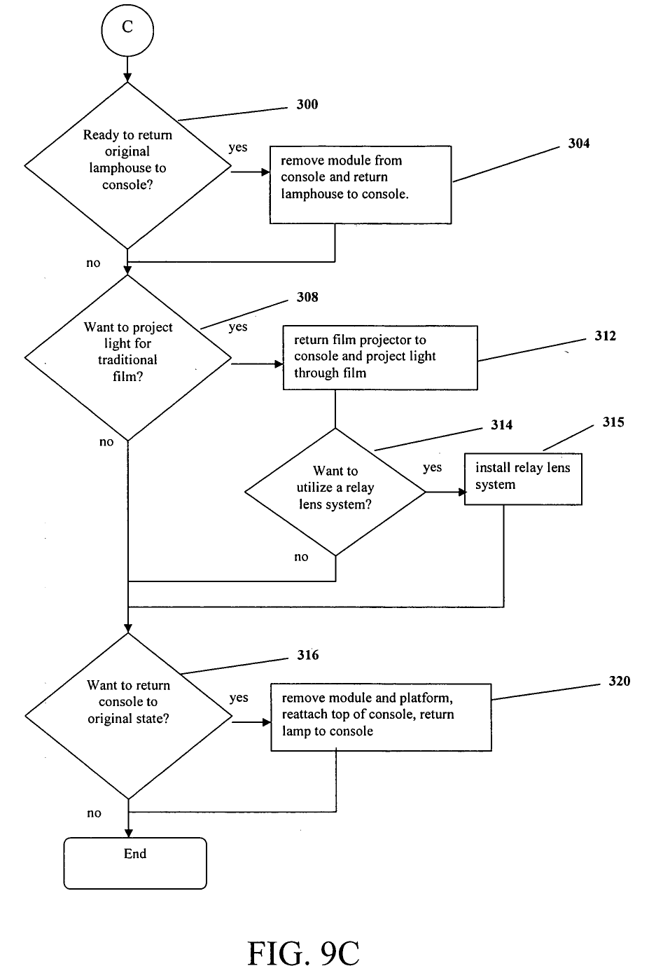

The present inventive subject matter also relates to a method of retrofitting a film projection console, and a system for doing the same. The process by which lamphouse components is replaced can vary widely. Although a flow chart is provided in Figures 9A, 9B, and 9C as a non-limiting example of this method, it is understood that the order of operations is not limited to that disclosed in the Figure, and that the steps of the method may be performed in many different orders, that not all of the steps shown therein are required, and that other steps may be performed as well. The method may be performed by projector manufacturers or dealers; by the owners or employees of the theater or other structure where the film projector is kept; by a hired third party; or by anyone who wishes to, or is asked to, retrofit a film projection console.

Making reference to FIGS. 9A, 9B, and 9C, the method is directed to the retrofitting of an existing film console, which may be disposed at a theater or other projection site. The method begins 200 by first asking 202 if a door needs to be removed. If so, one may 204 remove at least one door from the console; otherwise the door may simply be opened. Next, one 208 disconnects any wiring which connects the existing lamp to the console, and 228 removes the film projector from the front of the console, remembering that in some embodiments the projector can be returned after installation of the module 8.

A determination must be made 212 if the snood needs to be removed. In some circumstances, it can be advantageous to leave the snood in place, and allow it to shield the light output of the module 8. Other circumstances, however, may require the removal of the snood, for example, when the protrusions of the module 8, once installed, would extend beyond the snood or otherwise might not fit in the presence of the snood. Thus, if needed, one may 216 remove the snood from the console. In any case, the lamphouse components 220 must now be removed, which may include a lamp, reflector, and optical bench.

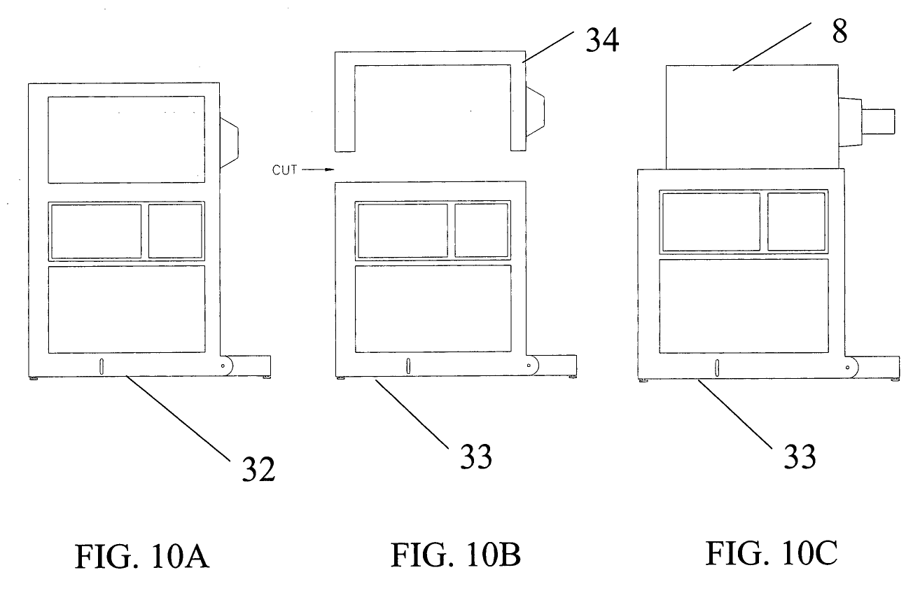

In order to accommodate the module 8, the console 32 may need to be cut in one or more ways. By reference to FIG. 10A, as a non-limiting example, one may have to cut the console 32 which normally encloses the lamphouse components completely into two portions. As shown in FIG. 10B, one leaves intact the base or shelf 33 where the traditional lamp assembly and optical bench normally sit, but removes a top 34. This cut can be performed with a plasma cutter, a reciprocating or rotary saw, a torch, a laser, or any other metal cutting device or method. As shown in FIG. 10C, the module 8 may then be mounted to the base 33. Generally, the lamphouse components in consoles made according to the existing art are mounted to a horizontal metal plate, which constitutes a shelf within the console enclosure. By removing these components and cutting away that portion of the enclosure above this shelf, it effectively becomes a flat table top, which may then be used to support new projection devices, including a digital projector device according to this and my previous inventions. A projector device may also be accommodated which is larger in height or width than the components previously located in that space. This table top may or may not require additional shims or blocks to accommodate and support the underside or the feet of the new projector device. By using care in the cutting process described herein, the interchangeability benefits of my invention can be maintained in that the new projector module device may later be removed, the top portion reattached, and the previous optical components reinstalled, thereby restoring the original functionality. Additional parts and steps may be required to reattach the top, such parts and procedures being obvious to those skilled in metal cabinet design and manufacture. Another embodiment of this invention involves only the removal of one or more of the four corners of the console frame 32, to make it easier to insert or remove a module 8, or to allow a portion of it to protrude after installation.

Returning to the method of FIG. 9, 232 if the console needs to be cut, one may 236 cut off the relevant portion of the console. 237 If a platform is needed to secure the module 8 in the appropriate place, one may 238 add a platform on which the module 8 may be mounted directly or by way of guide rails. Whether or not a platform is installed, one may consider the use of guide rails as set forth above. The module 8 may be mounted to an added platform with or without guide rails, or alternatively directly on the existing, original shelf of the console, using no additional platform, with or without guide rails.

240 If guide rails will be used, one may 244 attach the guide rails to the added platform, or to the existing, original shelf within the console, and then glide the module 8 into the console space 28 by way of the matching console guide rails 48. If no guide rails are to be used, one may proceed to 248 place the module 8 into the console space 28 and secure it in any desired fashion.

If the existing lamp power supply is to be used and 260 if a power filter is to be used, one may 264 wire a power filter inline between the existing lamp power supply and the module 8. Alternately, of course, the module may have its own power supply 36 as part of set 4, which can be wired to the module at any time. 268 If a folded light path projector module 8 will be used, the lamp assembly 16 can be 272 installed from the side, or from any other location. Otherwise, 273 a projector module with an in-line light path can be installed. 276 If the module 8 is to be wired to the existing console for control purposes, power purposes, or any other purpose, one may 280 wire the module to the console. If one wishes to close the console, one may reattach the previous door or use a new door. A new door may be advantageous if portions of the light path or other elements of the module 8 protrude out of the console space 28. 284 If one wishes to use a new door, one may 288 install a new door where the old door once was. At this time it is advantageous to 256 align the light output of the module (as non-limiting examples, toward a screen or through an aperture).

292 If a power control device is to be used, the power control device may be 294 installed and wired to the power supply output, the lamp, and any other device to which a connection will be advantageous.

The present inventive subject matter also discloses retaining the ability to use the retrofitted console for the projection of traditional film. As discussed above, one can replace the film projector in its original location and use the module 8 as a light source. In another embodiment, one can use just the lamp assembly 16 as an illumination source for the projection of film by removing said assembly from the module 8 and mounting it in the console lamphouse area, using the guide rails 48 or any other mounting means. Alternately, 300 if one wishes to return the original lamphouse components to the console, one may 304 remove the module 8 from the console (by unmounting it, by gliding it on the rails, or by any other method) and return the original light source, reflector, and other lamphouse components to the console (again, by mounting them on the existing platform or a new platform, by gliding them on rails, or by any other method). Whether one chooses to use the original lamphouse components or the module 8 or the lamp assembly 16 as a light source, 308 if one is ready to project light for traditional film, one may 312 return the film projector to the console and project light through the film. 314 If one wishes to use module 8 in conjunction with a relay lens system, one may 315 install a relay lens system at this time.

316 If one wishes to return the console to its original state, one may 320 remove the module and its platform (if used), reattach the top of the console, and return the lamphouse components to the console for traditional use.

The foregoing method may be used to convert virtually any cinema console to accept a module 8 or complete digital cinema projector, including, without loss of generality, those manufactured and/or supplied by Barco, Christie Digital Systems, NEC, Kinoton, Cinemeccanica, Sony, Kodak, Imax, or others.

The following non-limiting examples of methods for retrofitting existing film consoles (as listed by manufacturer and model) exemplify these steps:

Strong International, Model Highlight II and Super Highlight II Consoles:

Console structural modifications may be required, depending on the specific module 8 and console model.
1. The upper panels and doors are removed from the sides of the console.
2. The xenon lamp is removed.
3. The wiring connecting the lamphouse section to the console is disconnected.
4. The existing optical bench/plenum is removed by sliding it out the rear or side.
5. The film projector is removed from the front of the console.
6. The snood and front panel is removed from the console.
7. The frame is cut, if required.
8. A platform is added, if desired
9. The digital projector module guide rails 48 are installed if desired
10. The digital projector module unit is installed by sliding it in from the rear (or mounting it on the platform).
11. If a folded-path configuration module 8 unit is used, the lamp assembly 16 may be installed in the module 8 from the side after installation in the console.
12. The wiring to the projector module is connected.
13. The doors and panels are re-installed.
14. If a folded-path configuration digital projector module unit is used, or a larger digital projector is used, the previous operator side door may be replaced with a new door.
15. Power supply filter: Strong power supply model FXPS and HRPS require the filter module described herein to be added. Strong models 62 series switching power supplies may not require it.
   Christie Digital Systems Model SLC Console:
   Structural modifications to the console frame are required to accommodate any practical projector module 8 configuration.
1. The upper side doors are removed.
2. The xenon lamp is removed.
3. The wiring connecting the lamphouse section to the console is disconnected.
4. The optical bench/plenum is removed.
5. The film projector is removed from the front of the console.
6. The snood and front panel is removed from the front of the console (on units not having a removable front panel, only the snood is removed).
7. The opening at the front of the console may be expanded to obtain an opening approximately 19″ square. On versions with a removable front panel this requires cutting approximately two inches from both right and left sides of the existing opening. On versions without a removable front panel, the entire rectangular opening must be cut. In some embodiments the rear side may also be widened for ease of installation of the module. In yet another embodiment, the entire top portion of the console may be cut away for maximum ease of installation and access.
8. If the top portion of the console is removed, a platform is installed, if desired.
9. The digital projector module guide rails 48 are installed, if desired.
10. The digital projector module 8 is preferably slid in from the rear of the console, although it may be slid in from the front when convenient (or mounted on the platform).
11. If a folded-path configuration module 8 is used, the lamp assembly 16 is installed in the module 8 from the side after installation in the console.
12. The wiring is connected.
13. The doors and panels are re-installed.
14. If a folded-path configuration module 8 is used, the previous operator side door may be replaced with a new door.
15. Power supply filter: Christie reactive-type power supply model CCX series require a filter module to be added as described herein.
   Big Sky Models C2000 through C7000 Including “Deluxe” Models:
   Console structural modifications may be required, depending on the specific module 8 and console model.
1. The upper panels and doors are removed from the sides of the console.
2. The xenon lamp is removed.
3. The wiring connecting the lamphouse section to the console is disconnected.
4. The existing optical bench/plenum is removed.
5. The film projector is removed from the front of the console.
6. The snood and front panel is removed from the console.
7. The console frame is cut, if required to accommodate module 8.
8. If the top of the console is cut off, a platform is added, if desired.
9. The digital projector module guide rails 48 are installed, if desired.
10. The digital projector module 8 is installed by sliding it in from the rear (or mounting to the platform).
11. If a folded-path configuration module 8 is used, the lamp assembly 16 may be installed in the projector module 8 from the side after installation in the console.
12. The wiring to the module is connected.
13. The doors and panels are re-installed.
14. If a folded-path configuration module 8 is used, the previous operator side door may be replaced with a new door.
15. Power supply filter: IREM G3 series power supplies used in Big Sky consoles require the filter module described herein to be added.
   Xetron (Division of Neumade Products Corp):
   Console structural modifications may be required, depending on the specific module 8 and console model.
1. The upper panels and doors are removed from the sides of the console.
2. The xenon lamp is removed.
3. The wiring connecting the lamphouse section to the console is disconnected.
4. The existing optical bench/plenum is removed.
5. The film projector is removed from the front of the console.
6. The snood and front panel is removed from the console.
7. The console frame is cut, if desired to accommodate a projector module 8.
8. If the top of the console is cut off, a platform is installed, if desired.
9. The digital projector module guide rails 48 are installed.
10. The projector module 8 is installed by sliding it in from the rear (or mounting it on the platform).
11. If a folded-path configuration module 8 is used, the lamp assembly 16 may be installed in the module 8 from the side after installation in the console.
12. The wiring to the module is connected.
13. The doors and panels are re-installed.
14. If a folded-path configuration projector module unit is used, the previous operator side door may be replaced with a new door.
15. Power supply filter: IREM G3 and N3 series power supplies used in Xetron consoles require the filter module described herein to be added.
   Moving Image Technologies Model XLC Console:
   Console structural modifications may be required, depending on the specific module 8 and console model.
1. The upper panels and doors are removed from the sides and rear of the console.
2. The lamp is removed.
3. The wiring connecting the lamphouse section to the console is disconnected.
4. The optical bench/plenum is removed by sliding it out the rear.
5. The film projector is removed from the front of the console.
6. The snood is removed from the front of the console.
7. The console frame is cut, if desired to accommodate a larger module 8 than defined herein.
8. If the top of the console is removed, a platform is installed, if desired.
9. The digital projector module guide rails 48 are installed, if desired.
10. The digital projector module 8 is installed by sliding it in from the rear (or mounting it to the platform).
11. If a folded-path configuration module 8 is used, the lamp assembly 16 may be installed in the projector module 8 from the side after installation in the console.
12. The wiring is connected.
13. The doors and panels are re-installed.
14. If a folded-path configuration projector module 8 is used, the previous operator side door may be replaced with a new door.
15. Power supply filter: Not required for standard Moving Image Technologies consoles.

Having described the invention in detail and by reference to the embodiments thereof, it will be apparent that modifications and variations are possible, including the addition of elements or the rearrangement or combination or one or more elements, without departing from the scope of the invention which is defined in the appended claims.

What is claimed is:

1. A digital cinema projector set, the digital cinema projector set comprising
a digital cinema projector module, said digital cinema projector module comprising
a digital light engine;
a lamp assembly having a light source and a light path,
said light source and said light path being dimensionally configured for said digital cinema projector module to substantially occupy space intended for a lamphouse within a console for film projection.

2. The digital cinema projector set of claim 1, the set further comprising:
a lamp power supply.

3. The digital cinema projector set of claim 1, said digital cinema projector module further comprising:
projector guide rails which allow said digital cinema projector module to be installed in a console comprising corresponding console guide rails.

4. The digital cinema projector set of claim 3, wherein said projector guide rails and said console guide rails comprise a material with a low coefficient of friction.

5. The digital cinema projector set of claim 3, wherein said console guide rails form a track on which said projector guide rails may glide.

6. The digital cinema projector set of claim 3, wherein said console guide rails are aligned so that an output beam of said digital cinema projector module, when installed in said console, projects an image aligned to a screen.

7. The digital cinema projector set of claim 1, said digital cinema projector module being sufficient for use as a light source during projection of traditional film.

8. The digital cinema projector set of claim 1, said lamp assembly being sufficient by itself as a light source for projection of traditional film.

9. The digital cinema projector set of claim 1, the set comprising
a relay optical system able to focus an output beam of said digital cinema projector module into about an F/2.0 light cone for use as a light source for projection of traditional film.

10. The digital cinema projector set of claim 1, said light path comprising an approximately 90-degree prism which uses total internal reflection at a hypotenuse interface.

11. The digital cinema projector set of claim 1, said light path comprising a prism less than 90-degrees but more than 45-degrees, which uses total internal reflection at a hypotenuse interface.

12. The digital cinema projector set of claim 1, said light path comprising a prism which uses a dielectric coating on a hypotenuse glass-air interface, said coating allowing unwanted radiation to pass through, while reflecting visible light in a range between approximately 400 nm and approximately 700 nm in wavelength at an angle.

13. The digital cinema projector set of claim 1, said light path comprising a prism, said prism comprising an input face, an output face, and bandpass anti-reflection coating disposed at said input face and at said output face, said coating enhancing the passage of visible light in a range between approximately 400 nm and approximately 700 nm in wavelength, and reflecting light outside of said range.

14. The digital cinema projector set of claim 1, said light path comprising a prism, said prism usable in conjunction with additional lenses to reduce the angle of a light cone to below a critical angle, allowing total Internal Reflection to occur.

15. The digital cinema projector set claim 14, said prism comprising a concave input face and convex output face.

16. The digital cinema projector set of claim 1, the set comprising:
an electrical filter circuit capable of providing an instant current rate-of-rise sufficient to ignite a xenon lamp and sufficient steady-state current to maintain said ignition,
said electrical filter circuit capable of providing an extended current rise time of approximately one millisecond to minimize stress to lamp electrodes,
said electrical filter circuit allowing a current ripple of approximately 2% or less at all times, except when starting said lamp, thereby maintaining current ripple at or below a level sufficient for digital projection.

17. The digital cinema projector set of claim 1, the set further comprising:
a control module that allows automated or remote adjustment of the power supply output, and also permits remote monitoring of current status.

18. The digital cinema projector set of claim 17, said control module comprising:
an adjustable power control device, whereby said digital cinema projector module determines and controls power level delivered by said lamp power supply.

19. The digital cinema projector set of claim 1, said module comprising:
a width no greater than approximately 18″,
a height no greater than approximately 16″,
a length no greater than approximately 28″, and
a weight no greater than approximately 150 lbs.

20. The digital cinema projector set of claim 1, wherein said module is dimensionally configured to substantially replace one or more existing sets of lamphouse components in consoles selected from the group consisting of:
Strong International: X90, Highlight II, Super Highlight II models;
Christie Digital Systems: SLC models;
Big Sky: C2000 through C7000, Deluxe models;
Xetron (Division of Neumade): XCN, XCND, XH, XHN models;
and Moving Image Technologies: XLC models.

21. The digital cinema projector set of claim 1, said module being dimensionally configured for removal of said digital cinema projector module and return of an original lamphouse to said film projection console.

22. A method of retrofitting a film projection console with a digital cinema projector module, the method comprising:
disconnecting wiring which connects a lamp to said console;
removing lamphouse components from within said console; and
placing said digital cinema projection module inside said console.

23. The method of claim 22, the method further comprising:
removing at least one door from said console.

24. The method of claim 23, the method further comprising:
replacing said at least one door of said console with at least one new door configured to accommodate and enclose protrusions from said digital cinema projection module.

25. The method of claim 22, wherein said lamphouse components include said lamp, a reflector and an optical bench.

26. The method of claim 22, wherein the step of placing a digital cinema projection module into said console comprises:
mounting guide rails at said console; and
gliding said digital cinema projection module into said console along said guide rails.

27. The method of claim 22, the method further comprising:
wiring a power filter inline between said digital cinema projection module and a lamp power supply, said power filter being capable of providing an instant current rate-of-rise sufficient to ignite a xenon lamp and sufficient steady-state current to maintain said ignition,
said power filter being capable of providing an extended current rise time of approximately one millisecond to minimize stress to lamp electrodes,
said power filter allowing a current ripple of approximately 2% or less at all times, except when starting said lamp, thereby maintaining current ripple at or below a level sufficient for digital projection.

28. The method of claim 22, the method further comprising:
installing a lamp module in the side of said digital cinema projection module having a folded light-path configuration.

29. The method of claim 28, the method further comprising:
replacing a door with at least one new door configured to accommodate and enclose protrusions from said light-path configuration.

30. The method of claim 22, the method further comprising:
returning a film projector to said console; and
projecting light from said digital cinema projection module through film in said film projector.

31. The method of claim 30, the method further comprising:
utilizing a relay lens system disposed between said digital cinema projection module and said film projector to adapt the light output of the digital cinema projection module to an approximate F/2.0 light cone so as to be a more optimum light source for said film projector.

32. The method of claim 22, the method further comprising:
returning a film projector to said console; and
projecting light from a digital projector lamp module component of a digital projector or digital projection module through film in said film projector.

33. The method of claim 22, the method further comprising:
removing said digital cinema projection module from said console; and
returning said lamphouse components to said console.

34. The method of claim 22, the method further comprising:
removing a snood from said console.

35. The method of claim 22, the method further comprising:
wiring said digital cinema projection module to said console.

36. The method of claim 22, the method further comprising:
aligning the light output of said digital cinema projection module to project with maximum intensity onto a screen.

37. The method of claim 22, the method further comprising:
cutting off a top of said console with one of the group consisting of: reciprocating saw, rotary saw, plasma cutter, torch, laser.

38. The method of claim 37, the method further comprising:
adding a platform to a remaining portion of said console, and
mounting said digital cinema projection module to said platform.

39. The method of claim 37, the method further comprising:
removing said digital cinema projection module from said console;
reattaching the top of the console using welding or brackets; and
returning said lamp components to said console.

40. The method of claim 22, the method further comprising:
installing a control module that allows automated or remote adjustment of the power supply output, and also permits remote monitoring of status.

41. The method of claim 22, the method further comprising:
removing a film projector from said console.

42. A system for retrofitting a film projection console, the system comprising:
means for disconnecting wiring which connects a lamp to said console;
means for removing a film projector from said console; and
means for placing a digital cinema projection module inside said console.

43. The system of claim 42, the system further comprising:
means for removing at least one door from said console; and
means for returning at least one door to said console.

44. The system of claim 43, the system further comprising:
means for enclosing protrusions from said digital cinema projection module.

45. The system of claim 42, the system further comprising:
means for gliding said digital cinema projection module into said console along said guide rails.

46. The system of claim 42, the system further comprising:
means for wiring a power filter inline between said digital cinema projection module and a lamp power supply, said power filter being capable of providing an instant current rate-of-rise sufficient to ignite a xenon lamp and steady-state current sufficient to maintain said ignition,
said power filter being capable of providing an extended current rise time of approximately one millisecond to minimize stress to lamp electrodes,
said power filter allowing a current ripple of approximately 2% or less at all times, except when starting said lamp, thereby maintaining current ripple at or below a level sufficient for digital projection.

47. The system of claim 42, the system further comprising:
means for installing a lamp module in the side of said digital cinema projection module having a folded light-path configuration; and
means for enclosing protrusions from said light-path configuration.

48. The system of claim 42, the system further comprising:
means for returning a film projector to said console; and
means for projecting light from said digital cinema projection module through film in said film projector.

49. The system of claim 42, the system further comprising:
means for returning a film projector to said console; and
means for projecting light from a digital projector lamp module component of a digital projector or digital projection module through film in said film projector.

50. The system of claim 48, the system further comprising:
means for utilizing a relay lens system disposed between said digital cinema projection module and said film projector to adapt the light output of the digital cinema projection module to an approximate F/2.0 light cone so as to be a more optimum light source for said film projector.

51. The system of claim 42, the system further comprising:
means for removing said digital cinema projection module from said console.

52. The system of claim 42, the system further comprising:
means for removing a snood from said console.

53. The system of claim 42, the system further comprising:
means for wiring said digital cinema projection module to said console.

54. The system of claim 42, the system further comprising:
means for aligning the light output of said digital cinema projection module to project with maximum intensity onto a screen.

55. The system of claim 42, the system further comprising:
means for cutting off a top of said console.

56. The system of claim 55, the system further comprising:
means for adding a platform to the top of a remaining portion of said console; and
means for mounting said digital cinema projection module onto said platform.

57. The system of claim 55, the system further comprising:
means for removing said digital cinema projection module from said console;
means for reattaching the top of said console; and
means for returning said lamp components to said console.
